(19) United States
(12) Patent Application Publication
(10) Pub. No.: US 2018/0225625 A1
(43) Pub. Date: Aug. 9, 2018

(54) Inventory Management System and Method

(71) Applicant: Cornelius, Inc., Osseo, MN (US)

(72) Inventors: Vincenzo DiFatta, Wood Dale, IL (US); Clayton Knight, Elgin, IL (US); Arsalan Aslam, Bloomingdale, IL (US); Sandesh Aravinda, Carol Stream, IL (US); Ravi Kumar, Tumkur (IN); Michal Augustyniak, Bloomingdale, IL (US)

(73) Assignee: Cornelius, Inc., Osseo, MN (US)

(21) Appl. No.: 15/890,073

(22) Filed: Feb. 6, 2018

Related U.S. Application Data
(60) Provisional application No. 62/454,966, filed on Feb. 6, 2017.

(51) Int. Cl. G06Q 10/08; G06K 7/10; B65G 1/137

(52) U.S. Cl. CPC G06Q 10/087; G06K 7/10376; A47F 3/0404; G06K 7/10237; B65G 1/137; G06K 7/10861

(57) ABSTRACT

An inventory management system includes a scanning system moved by a pulley system to scan a series of inventory locations, such as in a retail display, and determine respective inventory amounts at each inventory location. The scanning system includes a distance sensor that measures the distance to a retail item at the inventory location, and a transmitter that wirelessly transmits the distance measurement. A pulley system moves the scanning system along at least one axis and comprises at least two pulleys, a stationary motor, and a connection line connected to the scanning system. A controller controls the stationary motor to move the scanning system to an aligned position with each inventory location in a series of inventory locations. The inventory management module is configured to determine an inventory amount at each inventory location based on the distance measurement at the respective inventory location.

### CROSS-REFERENCE TO RELATED APPLICATION

The present application is based on and claims priority to U.S. Provisional Patent Application Ser. No. 62/454,966 filed Feb. 6, 2017, the disclosure of which is incorporated herein by reference.

### FIELD

This disclosure generally relates to inventory management systems and methods and, more particularly, to methods and systems having a scanning device that measures current inventory, such as in a retail display, and performs inventory assessment.

Inventory management is becoming increasingly important, especially in a retail environment. Retailers are continuously adapting and changing retail atmospheres and developing new planograms for retail environments. A planogram is a diagram that shows how and where specific retail products should be placed on retail shelves. Planograms may be created or revised to optimize product placement for increasing customer purchases, maximizing revenue, promoting particular products, or the like. It is generally important to retailers that they maintain a certain level of inventory available on a retail floor, and that such inventory is presented and organized in accordance with a particular planogram. Thus, measuring inventory level and planogram compliance is desirable.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In one embodiment, an inventory management system includes a scanning system moved by a pulley system to scan a series of inventory locations, such as in a retail display, and determine respective inventory amounts at each inventory location. The scanning system includes a distance sensor that measures the distance to a retail item at the inventory location, and a transmitter that wirelessly transmits the distance measurement such that it is received by an inventory management module. A pulley system moves the scanning system along at least one axis and comprises at least two pulleys, a stationary motor, and a connection line connected to the scanning system. A controller controls the stationary motor to move the scanning system to an aligned position with each inventory location in a series of inventory locations. The inventory management module is configured to determine an inventory amount at each inventory location based on the distance measurement at the respective inventory location.

A method of assessing inventory in a retail display includes operating a pulley system to move a scanning system to an aligned position with each inventory location in a series of inventory locations. At each inventory location, the scanning system is operated to measure a distance to a retail item, and the distance measurement is wirelessly transmitted to a receiver. An inventory amount is then determined for each inventory location based on the distance measurement at that inventory location.

### BRIEF DESCRIPTION OF THE DRAWINGS

The present disclosure is described with reference to the following Figures.

FIG. 1 is a schematic representation of an exemplary inventory management system in accordance with the present disclosure.

FIG. 2 is a schematic representation of an inventory management system operating at an inventory location.

FIGS. 3-5 depict another embodiment of a scanning system and pulley system installed in an upright cooler.

FIGS. 6-7 depict another embodiment of a pulley system and scanning system mounted on a frame behind a shelving unit.

FIGS. 8-10A and 10B depict another embodiment of a pulley system and scanning system associated with a bulk bin system.

FIG. 11 is a display showing an exemplary output display of an inventory management system.

FIGS. 12 and 13 depict an exemplary method, or portions thereof, of assessing inventory in a retail display according to the present disclosure.

### DETAILED DESCRIPTION

The inventors have recognized a need for an inventory management system and method that provides automatic inventory tracking and reporting for inventory on retail shelves and in retail coolers, and in other retail display areas (such as for tracking inventory in large coolers and refrigerators at retail locations). Such information is valuable for making sure that a retail environment remains properly stocked. As part of this, the inventors recognized a need for a system capable of automatically determining and monitoring planogram compliance. The inventors recognized that inventory tracking data can be compared to a planogram to determine whether the planogram is being followed, and to identify deviations from a planogram. The inventors recognized that such planogram compliance information may be extremely valuable to retailers and product owners because, for example, it can increase the reliability of associations between sales data and particular planograms.

Moreover, upon experimentation and research in the relevant field, the inventors recognized that systems and method of inventory tracking that require separate inventory sensing and/or measurement devices at each inventory location are expensive and overly prone to sensor malfunction or error, and thus are undesirable. Thus, the inventors recognized a need for a single inventory scanning system capable of moving around a scanning plane covering multiple inventory locations and capable of monitoring and measuring inventory across an entire retail area, such as across a shelving unit, upright cooler, or series of bulk bins.

As a result of recognition of the foregoing needs and problems in the relevant industry, the inventors developed the disclosed inventory management system and method disclosed herein, which is a flexible inventory management system that is customizable to a wide variety of inventory environments, including retail coolers and refrigerators of all sizes, retail shelving, bulk bins, or any number of other retail display environments. Additionally, the disclosed system consumes minimal energy and, in certain embodiments, can be produced at relatively low cost.

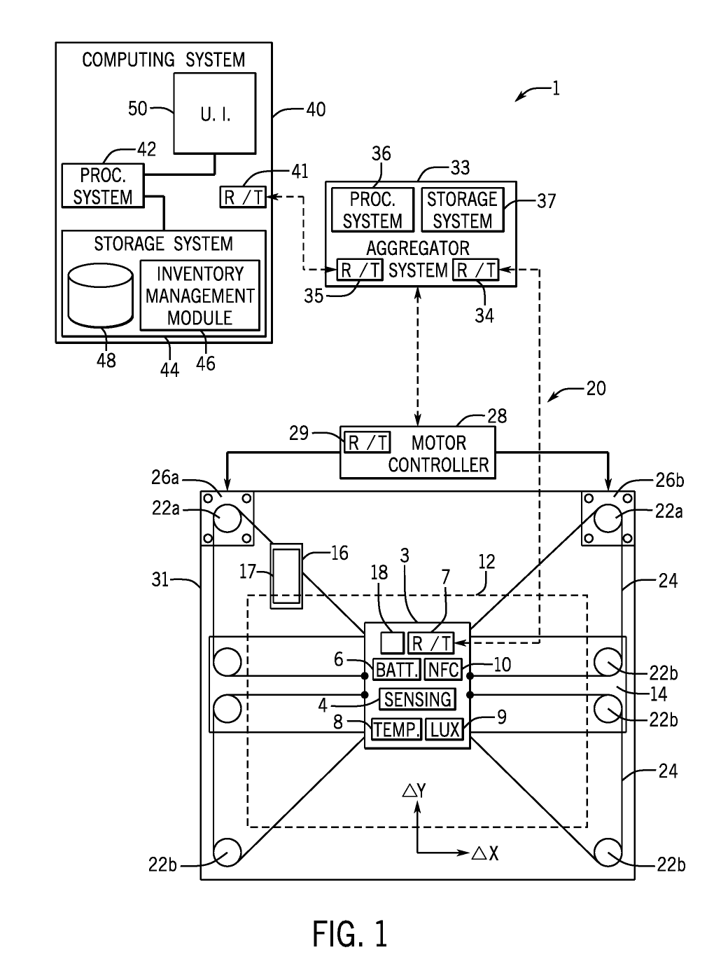

FIG. 1 provides a schematic view of one embodiment of an inventory management system 1. The inventory management system 1 includes a scanning system 3 having a distance sensor 4 that measures a distance to a retail item at each of a series of inventory locations, such as in a retail shelving unit or upright cooler, a set of bulk bins, or in some other system for holding items for purchase in a retail environment. A pulley system 20 moves the scanning system 3 along at least one axis in order to move the distance sensor 4 to each inventory location in the series of inventory locations. In the embodiment depicted in FIG. 1, the pulley system 20 moves the scanning system 3 along both the horizontal axis X and the vertical axis Y within the scanning plane 12. The scanning system 3 is aligned with each inventory location such that the distance sensor 4 can scan a distance at each inventory location throughout the scanning plane 12 in order to measure an inventory amount.

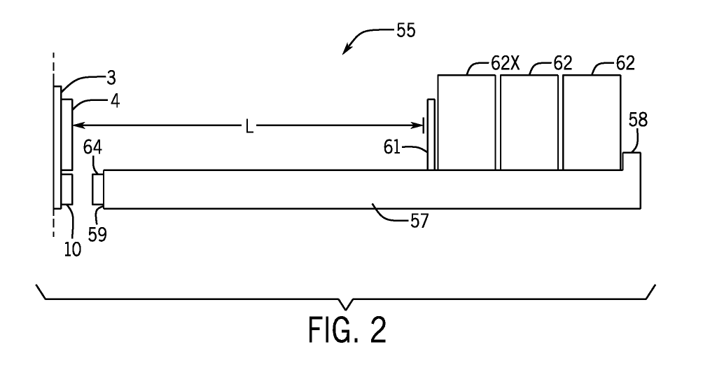

FIG. 2 schematically depicts a cross-section of an inventory location 55 where a distance sensor 4 is measuring a distance L to a rear-most retail item 62x. At the depicted inventory location 55 three items 62 sit on shelf 57. A pusher 61 pushes the items 62 toward a front edge 58 of the shelf 57 such that the items are maintained toward the front of the shelf. In other embodiments that retail items 62 may be forced toward the front edge 58 of the shelf 57, by other means. Thereby the retail items 62 are accessible by consumers and a pleasing visual appearance of the retail environment is maintained.

The distance sensor 4 measures the distance L to the rear-most retail item 62x, and thus a distance not occupied by the retail items 62. In the depicted embodiment, the measurement is effectuated by measuring a distance to the pusher 61, which is against the rear-most item 62x. In other embodiments, the distance sensor 4 may measure the distance to the actual retail item 62, or to some other proximate location representative of or correlating to the location of the amount of space occupied by the retail items 62 at that particular inventory location 55. The distance sensor 4 may be any device capable of sensing the distance L between the distance sensor 4 and an item. In one exemplary embodiment, the distance sensor 4 is a laser range sensor having a laser emitter and a collector. For instance, the distance sensor 4 may be a Time-of-Flight (ToF) laser ranging sensor by STMicroelectronics, such as the VL53L0X. In other embodiments, the distance sensor 4 may be an ultrasonic range sensor, or a LIDAR range sensor, or any other type of range finder or proximity sensor. To provide just one additional explanatory example, the distance sensor 4 may be a Lidar Light V3 by Garmin Ltd.

In certain embodiments, the scanning system 3 may include a tag reader 10 that reads a tag 64 associated with each inventory location 55. The tag 64 provides an item identification identifying a retail item 62 housed at the inventory location 55. In various examples, the item identification may be a general identification of the type of retail item (e.g., 12 oz beverage can, or small/med/lg beverage container, etc.), or may identify further level of detail on the retail item contained at the inventory location 55 (e.g., 12 oz Diet Coke can). In one embodiment, the tag reader 10 may be a near field communication (NFC) reader and the tag 64 is an NFC tag. In other embodiments, the tag reader may be any type of device capable of reading the associated tag 64. For example, the tag 64 may be a barcode, QR code, or other visual code depiction, and the tag reader 10 may be a corresponding barcode scanner or QR code scanner or imaging device. The tag is arranged at a location so as to be readable by the tag reader 10 when the scanning system 3 is at the inventory location 55. In the depicted embodiment, the tag 64 is fixed to the back edge 59 of the shelf 57 and positioned such that the tag reader 10 is in very close proximity to the tag 64 when the scanning system 3 stops at the inventory location 55.

In addition to the distance sensor 4 and the tag reader 10, the scanning system 3 may include one or more of a temperature and/or humidity sensor 8 and a light sensor 9. The temperature/humidity sensor 8 senses a temperature and/or a humidity of the air in its proximity. For example, the sensor 8 may be a thermistor mounted on the surface of the scanning system 3. In another embodiment, the sensor 8 may be a capacitive-type humidity and temperature sensor providing a digital-output of relative humidity and temperature. In certain examples, the temperature and/or humidity may be measured at a plurality of locations within the scanning plane 12 as the scanning system 3 moves about the scanning plane 12. The light sensor 9 may be any sensor capable of determining a light level surrounding the scanning system 3, or the portion containing the light sensor, such as a photodiode. The light level may be used to assess certain conditions and operations within a storage environment, such as a cooler.

The scanning system 3 also includes a battery 6 powering the devices on the scanning system 3. For example, the battery 6 may be a standard lithium ion battery. In other embodiments, especially where the scanning system 3 has a low enough power draw, the battery 6 may be an electric double layer capacitor battery (a “supercap”). The battery power is preferably sufficient to power the scanning system 3 functionality through at least one entire scanning process of the inventory locations 55 in the scanning plane 12. In the embodiment of FIG. 1, the battery 6 is charged when the scanning system 3 is located at the base station 16. Namely, when the scanning system 3 is not being moved by the pulley system 20 to execute a scanning routine, it is held at the base station 16, which contains a battery charger 17. For example, the battery charger 17 may be an inductive charger transmitter 17a associated with an inductive charger receiver 18 on the scanning system 3 and connected to the battery 6. For example, the charging system may leverage the Qi inductive charging standard interface.

The information collected by the devices on the scanning system 3 is transmitted by a receiver/transmitter 7 on the scanning system 3. In the depicted embodiment, the sensed information is transmitted by receiver/transmitter 7 to an aggregator system 33, which then transmits the information to a computing system 40. Specifically, the aggregator system 33 has a receiver/transmitter 34 configured to receive the information from the receiver/transmitter 7. The receiver/transmitter 7 and the receiver/transmitter 34 may communicate by any wireless communication protocols or means such as Bluetooth, Bluetooth low energy (BLE), ZigBee, Z-Wave, Wi-Fi, RF transmission on ISM band, or the like. The aggregator system 33 may also include a separate receiver/transmitter 35 for communication with the computing system 40 (which includes receiver/transmitter 41), which may be by a different wireless protocol than communication with the receiver/transmitter 7 on the scanning system 3. In other embodiments, the aggregator system 33 may include only one receiver/transmitter to handle all communications between it and both the scanning system 3 and the computing system 40.

The aggregator system 33 includes a processing system 36 and a storage system 37. The storage system 37 may house software, such as control software to execute control instructions for managing the pulley system 20 and/or the scanning system 3. For example, the control functionality of the aggregator system 33 may be programmable, such as programmable through the user interface 50 of the computing system 40. Control software stored in the storage system 37 of the aggregator system 33 is executable by the processing system 36 in order to carry out certain aspects of the inventory management methods and system controls described herein.

The aggregator system 33 provides control instructions to be executed by the motor controller 28 which controls the motors 26 driving the pulley system 20. Control instructions may be individually configured for each scanning plane 12. The control instructions may identify, for example, XY coordinate positions within a two dimensional scanning plane where the scanning system 3 is to be placed in order to be aligned with and scan a series of inventory locations 55. In other embodiments, such in the bulk bun scanning embodiment described below, the control instructions may identify scanning positions on a single axis. In still other embodiments, the control instructions may identify scanning positions by other means, such as based on detection of a tag 64. In certain embodiments, the aggregator system 33 may be a stand-alone electronic system, or may be incorporated into, or provided on a single board with, the motor controller 28, or alternatively may be incorporated into the computing system 40.

The pulley system 20 includes at least two pulleys 22, including a driver pulley 22a and a passive, or driven, pulley 22b. A connection line 24 connects between each of the pulleys 22a and 22b and the scanning system 3. A stationary motor 26 is connected to the driver pulley 22a in order to move the connection line 24 to thereby move the scanning system 3. In the depicted embodiment, a CoreXY Cartesian Motion Platform is implemented, which is capable of moving the scanning system 3 in both the vertical direction and the horizontal direction throughout the scanning plane 12. The particular depicted embodiment of the pulley system 20 in FIG. 1 includes eight pulleys 22, total, including two driver pulleys 22a and six driven pulleys 22b. The driver pulleys 22a are each connected to a respective motor 26a and 26b. The motors 26a and 26b rotate the respective driver pulley 22a in the clockwise and counterclockwise rotational directions and various speeds in order to move the scanning system 3 throughout the scanning plane 12. The stationary motors 26a and 26b may be any type of motor capable of rotating the driver pulley 22a. For example, the motors 26a and 26b may be DC electric motors, such as stepper motors. Specifically, when both motors are rotated in the same direction, either both rotated clockwise or both rotated counterclockwise, horizontal motion is effectuated. Rotation of both the motors in opposite directions from one another, results in vertical motion of the scanning system 3. Diagonal motion is also possible where the motors 26a and 26b are rotated at different speeds from one another. An important benefit of moving the scanning system 3 via the described Core XY pulley system 20 is that the weight of the motors, which are one or more stationary motors 26 fixedly mounted to a frame or other infrastructure, are removed from the scanning system, thereby removing a large inertial component from the moveable portion and making it easier and more energy efficient to move the scanning system 3.

The driver pulleys 22a move the connection line 24 with respect to the pulleys 22a, 22b. For example, each driver pulley 22a may drive the connection line 24 due to friction contact between the driver pulley 22a and the connection line 24. In other embodiments, the driver pulley 22a may have a toothed surface that contacts the connection line 24 in order to exert force thereon. The connection line 24 may be any rope, cable, belt, or the like capable of connecting between the pulleys and the scanning system 3. For example, the connection line 24 may be a braided stainless steel cable. Alternatively the connection line 24 may be a rubber belt, examples of which are described below.

The pulley system 20 is mounted to a mounting surface 31, such as by mounting the motors 26a and 26b and the driver pulleys 22a, as well as one or more of the driven pulleys 22b to the mounting surface 31, which is fixed. In certain embodiments, some of the driven pulleys 22b may be mounted to a carrier plate 14, on which the scanning system 3 is supported a horizontally movable. The carrier plate 14 then moves vertically under certain rotation conditions of the two motors 26a and 26b. The scanning system 3 slides horizontally on the carrier plate 14, such as to scan a row of inventory locations 55. Thus a low friction interaction between the back surface of the scanning system 3 and the carrier plate 14 may be desirable. In certain embodiments the scanning system 3 is attached to the carrier plate 14, such as on a slideable track. In other embodiments, there is no retention means between the scanning system 3 and the carrier 14, and the scanning system 3 is held against and slid across the carrier plate 14 due to the tension and motion of the connection lines 24 connected thereto.

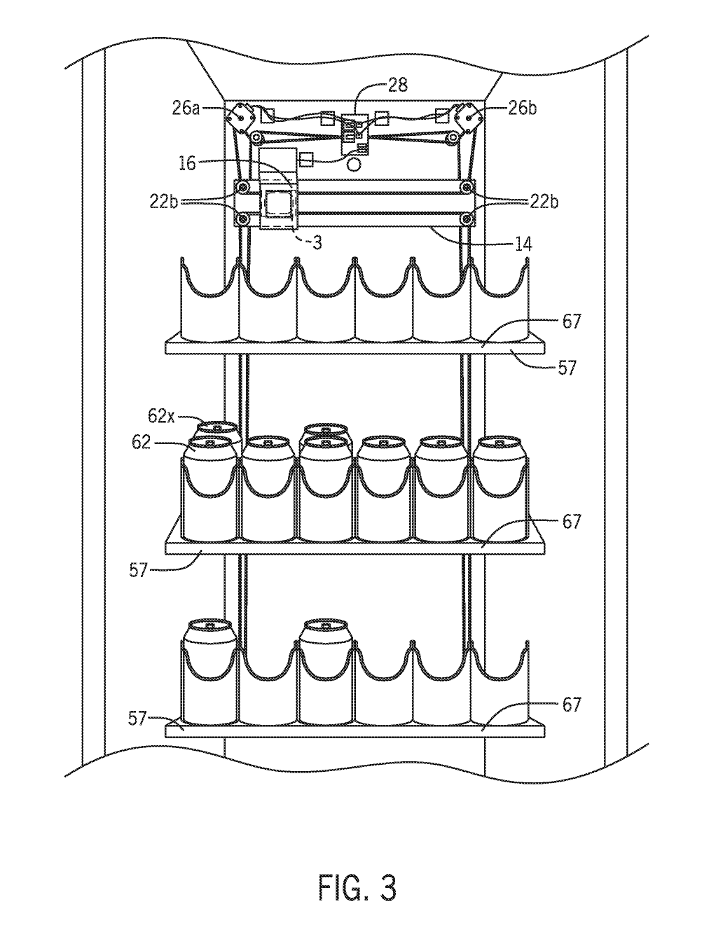

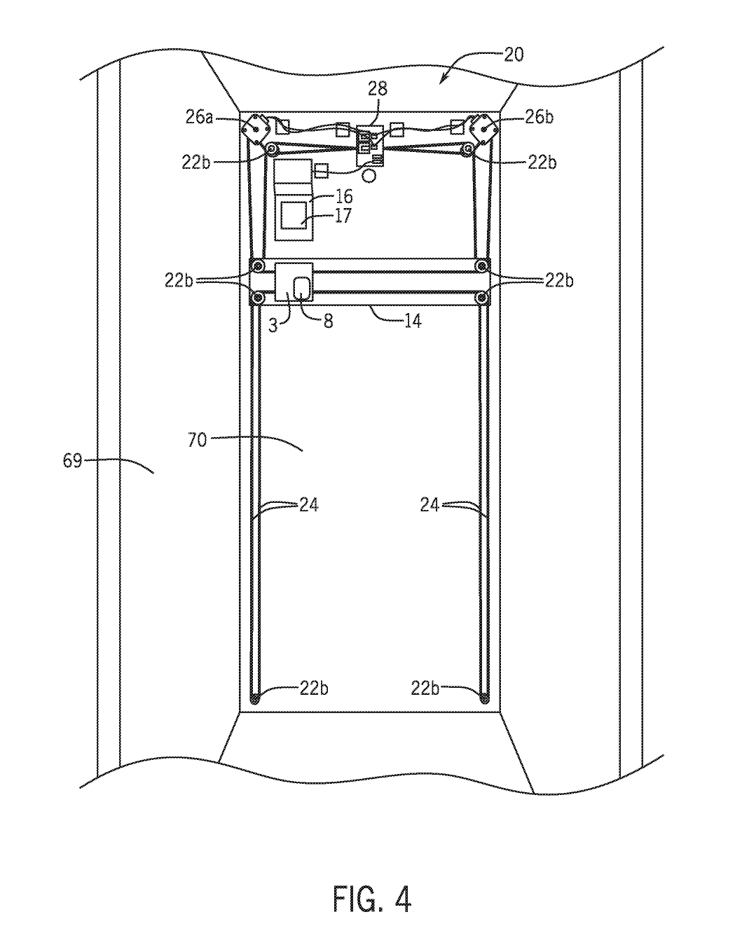

In various embodiments, the pulleys 22 may be arranged in any number of configurations or patterns, and any number of two or more pulleys may be provided (with at least one driver pulley 22a and one driven pulley 22b). FIGS. 3-5 depict the pulley system 20 and scanning system 3 installed inside an upright cooler 69. FIG. 3 depicts the scanning system 3 positioned at the base station 16, where the inductive charging system 17a and 18 can charge the battery 6 on the scanning system 3. FIG. 4 depicts the scanning system 3 moved away from the base station 16 and at a location in the scanning plane. The pulley system 20 is installed on the back wall 70 of the upright cooler 69 such that it is mounted behind the shelving unit 67 in the cooler. Thereby, the scanning system 3 is moved around behind the shelves 57 of the shelving unit 67 and positioned at each inventory location 55 in order to measure the distance to the rear-most item 62x at each inventory location 55 (FIG. 2). In the example, the pulley system 20 includes ten driven pulleys 22b and two driver pulleys 22a, each driver pulley 22a associated with each of the motors 26a and 26b. The pulleys are arranged in order to optimally position the connection line 24 for functionality in the upright cooler 69.

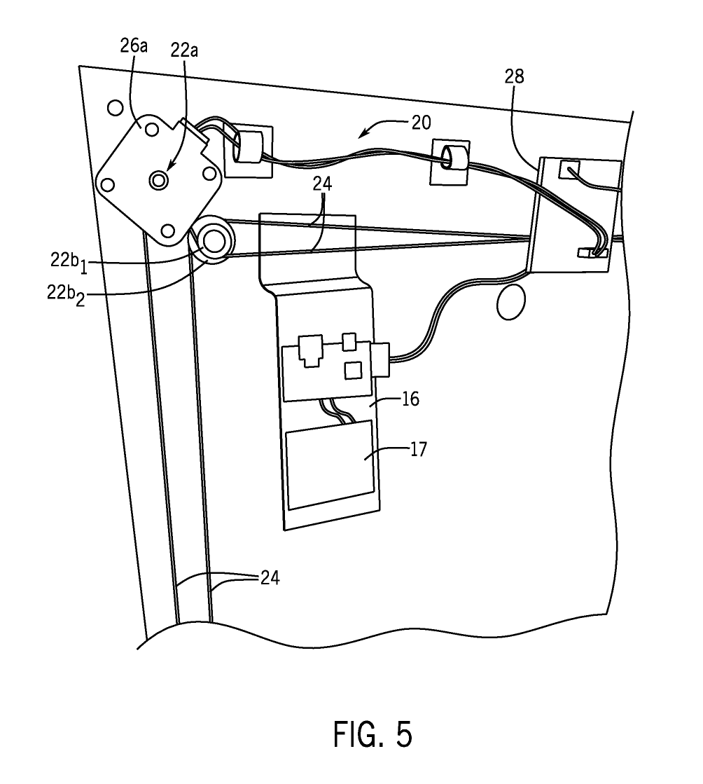

As shown most clearly in FIG. 5, the pulley system 20 includes an additional set of driven pulleys 22b₁ and 22b₂ adjacent to each motor 26a, 26b. These driven pulleys 22b₁ and 22b₂ position the connecting line 24 in a way that is desirable for the depicted embodiment. The driven pulley 22b₁ shifts the connection line 24 to the outer perimeter of the back wall 70 so that it does not crisscross through the middle of the wall. The driven pulleys 22b₂ guide the connection line 24 as it exits the motor 26a, 26b in order to increase the frictional contact between the connection line 24 and the driver pulley 22a.

In other embodiments, the pulley system 20 may be installed on an exterior, backside of the upright cooler 69, to remove it from the inside of the upright cooler 69. However, the scanning system 3 remains on the interior of the upright cooler 69 so that the various sensing operations can occur. The scanning system is moved by the pulley system 20 by moving a magnet on the backside of the upright cooler 69. More specifically, the connection line 24 is attached to a magnet that is moved around the backside of the upright cooler 69 by the pulley system. The scanning system 3 is attracted to the magnet and is retained against the back wall 70 of the upright cooler 69 due to the magnetism of the magnet. As the magnet moves on the exterior backside of the upright cooler 69, the scanning system 3 is moved correspondingly along the interior back wall 70 of the upright cooler 69. Such an embodiment has the benefit of keeping the elements of the pulley system 20 out of the inside of the cooler 69 so as to move through the scanning plane 12. Thus, the back wall 70 of the upright cooler is a completely cleanable surface, as the scanning system 3 can simply be removed by pulling it hard enough to overcome the force of the magnetic field and the entire upright cooler 69 is an undisturbed and cleanable surface.

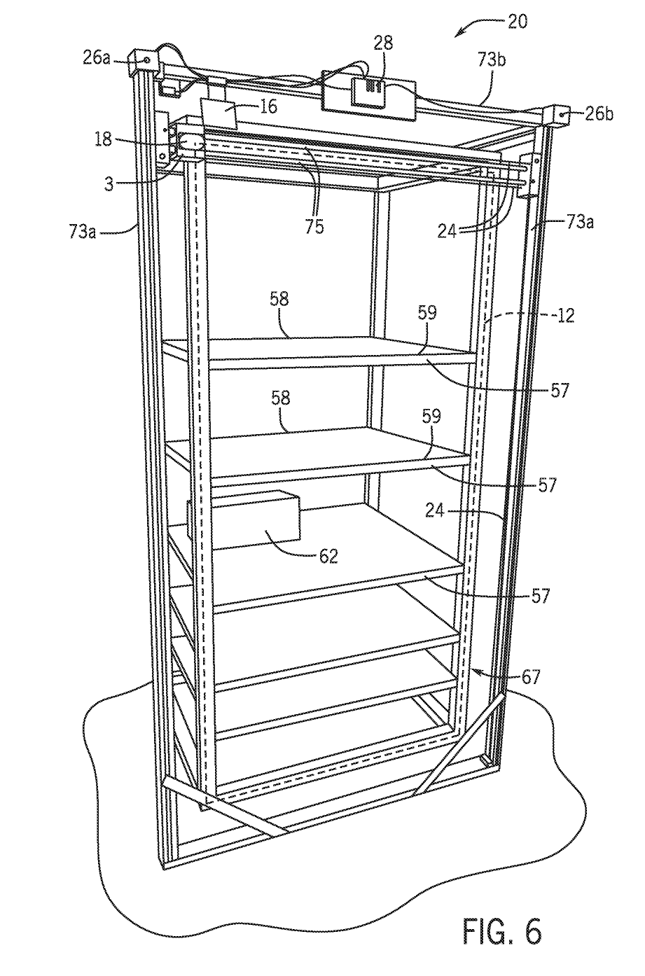

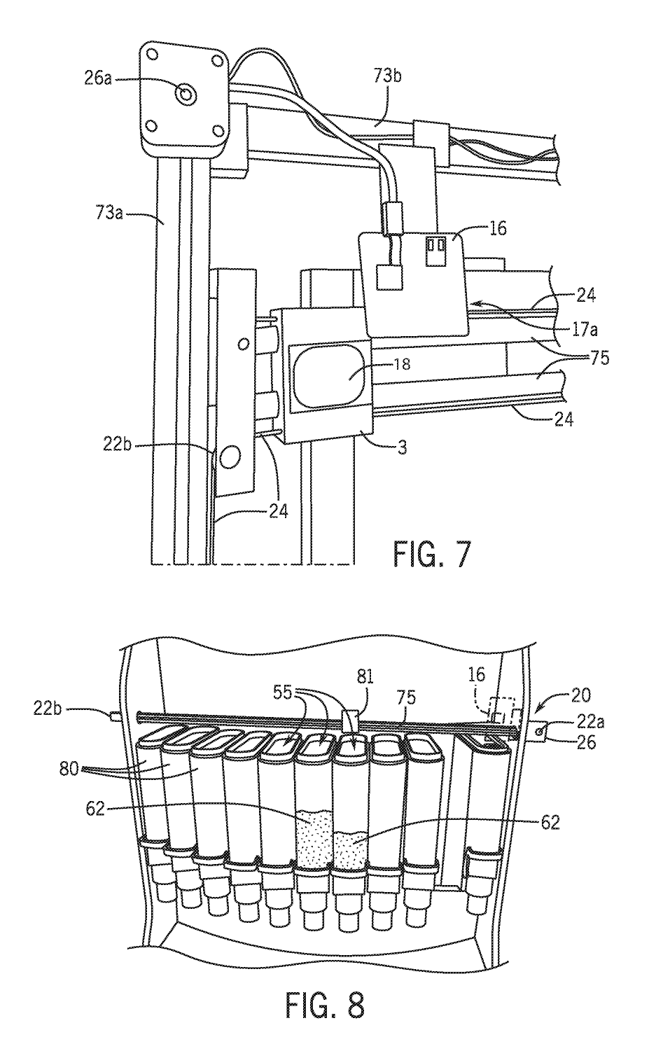

FIGS. 6 and 7 depict another embodiment of the pulley system 20 that moves the scanning system 3 in both the horizontal and vertical directions throughout a scanning plane 12. The scanning system 3 is supported on a rail 75, or in this case a pair of rails 75. The rail 75 moves vertically on a frame 73 behind the shelving unit 67, which comprises multiple shelves 57 each configured to hold retail items 62 to be inventoried. The shelving unit 67 may be of any construction. In certain embodiments, the shelving unit 67 has angled shelves 57 that are angled to cause the items to slide forward toward the front edge 58 of the shelf 57. In certain embodiments, it is preferable to have some mechanism or force that pushes the items forward toward the front edge 58 of the shelf 57, such as a pusher 61 described above or by gravity in the instance of an angled shelf 57.

The frame is positioned on the back side of the shelving unit 67 such that the scanning occurs from the rear side of the shelf 57 (similar to the upright cooler embodiment described above). The frame 73 includes two side pieces 73a extending vertically along the vertical length of the shelving unit 67, and a top frame piece 73b extending horizontally along (or above) the top of the shelving unit 67. In certain embodiments it is desirable to place the motors 26a, 26b and the motor controller 28 on the top frame piece 73b so that it is out of the scanning plane 12 and also does not interfere with shelf restocking, cleaning, or maintenance. Additionally, this protects the motors 26 and other pulley system 20 elements from damage. In certain embodiments, the frame 73 may also include a bottom frame piece. However, the inventors have recognized that it may be desirable to avoid having a bottom frame piece, as it can interfere with movement of items in and out of the shelving unit 67, as well as adjustment of the shelving unit 67 itself. Accordingly, the frame 73 may extend around the sides and above the top of the shelving unit 67.

The rail 75 supporting the scanning system 3 moves vertically on the side frame pieces 73a as it is pulled by the connecting line 24, which runs along the interior length of each side frame piece 73a. As depicted in FIG. 7, the connecting line 24 also extends along the rail 75, in this embodiment above and below the set of rails 75. For example, the connection line 24 in the embodiment of FIGS. 6 and 7 may be a tooth belt, such as made of rubber, synthetic rubber, nylon, or other appropriate and flexible material.

FIGS. 6 and 7 depict the scanning system 3 approaching the base station 16, where the inductive charging system can charge the battery 6 on the scanning system 3. In the depicted embodiment, the base station 16 is suspended from the top frame piece 73b. The base station 16 is above the shelving unit 67 and thus above the scanning plane 12. When not conducting a scanning operation of the scanning plane 12 the scanning system 3 rests at the top corner of the system, where it is aligned with the base station 16. The depicted embodiment incorporates an inductive charging system where the inductive charging transmitter 17a is on the front side of the plate establishing the base station 16. The scanning system 3 crosses in front of the battery charger transmitter plate 17a. The inductive charger receiver 18 is on a back side of the scanning system 3, and thus aligns with the battery charger transmitter 17a when the scanning system 3 is aligned with the base station 16. In other embodiments, the scanning system 3 may

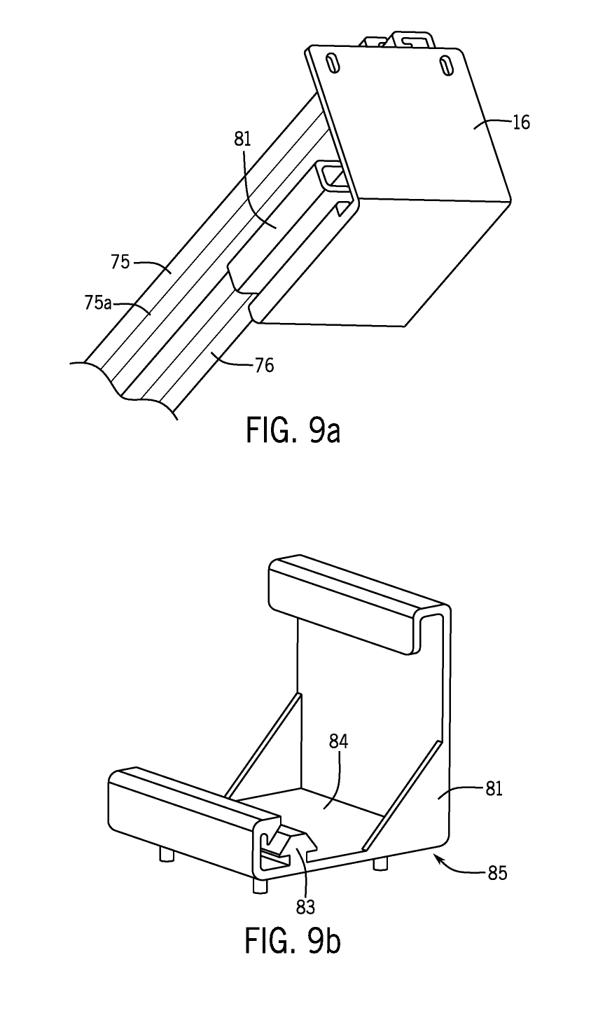

FIGS. 8-10A and 10B depict another embodiment of a pulley system 20 and scanning system 3 arrangement for an inventory management system 1. In those depicted embodiments, the scanning system 3 moves on a rail 75 that extends above one or more bulk bins 80. The pulley system 20 moves the scanning system 3 along the rail 75, and thus along a single axis. Since the pulley system 20 only moves the scanning system 3 along one axis, only one motor is required. In the depicted embodiment, a motor 26 is positioned at one side of the rail 75. A driver pulley 22a is rotated by the motor 26, and a driven pulley 22b is positioned at the opposite end of the rail 75. The connecting line 24 runs along the rail 75, and in the depicted embodiment is recessed into the rail 75. The connecting line 24 connects to a cart 81 on which the scanning system 3 is mounted. For example, the connection line 24 may connect to the hook piece 83 that hooks to and slides within a track 76 in the rail 75. Accordingly, the cart 81 is moved along the length of the rail 75 to an inventory location 55 above each bulk bin 80. The distance sensor 4 then measures a distance to the bulk item 62 level contained in each bulk bin 80. Thereby, an inventory amount of the bulk item 62 can be determined—e.g. how empty or full the bulk bin 80 is.

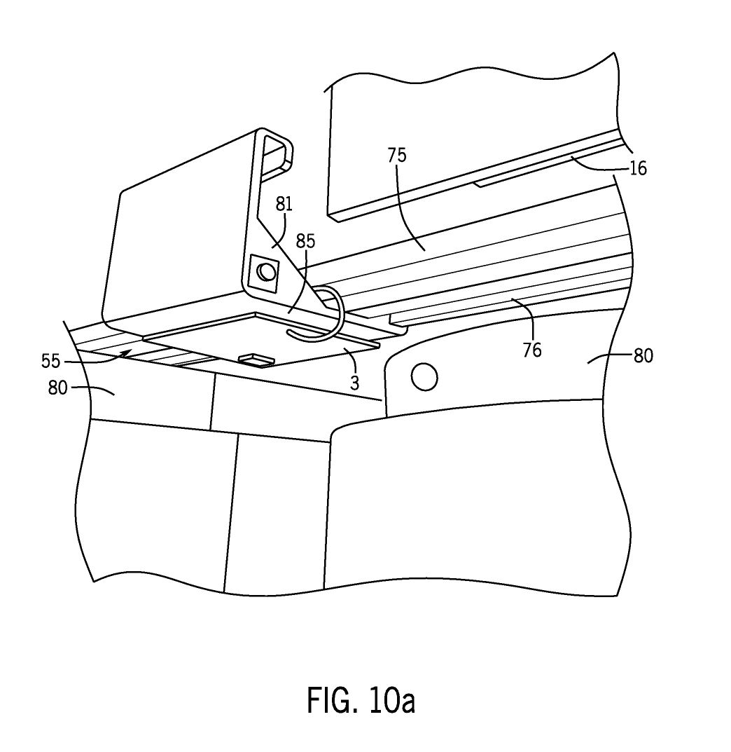

FIGS. 9A and 9B depict one embodiment of the rail 75 having a track 76, and a cart 81 that slides in the track 76. In the depicted embodiment, the hook piece 83 is an arrow-shaped piece that extends over edges of the track and thereby suspends the cart 81 to the bottom side 75a of the rail 75. In just one exemplary embodiment, the rail 75 is formed of aluminum and the cart 81 is an extruded plastic.

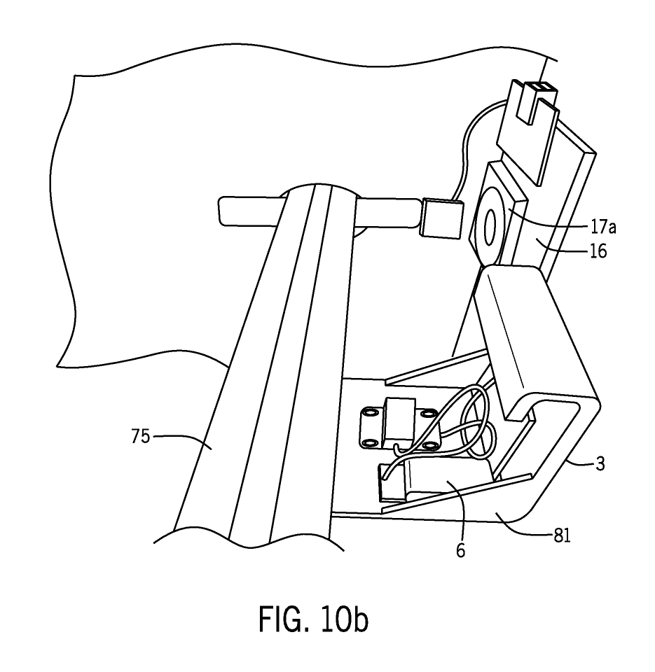

Base station 16 may be positioned at one end of the rail 75, such as exemplified in FIG. 10B. The cart 81 is moved to that end and into alignment with the base station 16 in order to be charged by the inductive charger 17a. As shown in FIG. 10A, the scanning system 3 may mounted to a bottom side 85 of the cart 81 with certain portions, including the battery 6 and charging circuitry, being mounted to or supported on a top side 84 of the cart 81. The distance sensor 4 is mounted to the bottom side 85 of the cart 81 such that when the cart 81 is positioned at an inventory location 55 above a bulk bin 80, the distance sensor measures a distance to the bulk item 62 contained in the bulk bin 80. Any of various distance or proximity sensing devices may be used, as described above. In certain embodiments, measurement of bulk items 62 in bulk bins 80 may be best measured by an ultrasonic distance sensor 4, such as an ultrasonic ranging module HC-SR04 by Spark Fun Electronics.

The computing system 40 receives the distance measured by the distance sensor 4, and may also receive information from other elements on the scanning system 3, such as the tag reader 10, temperature and/or humidity sensor 8, and light sensor 9. The computing system 40 includes a processing system 42, a storage system 44, and a user interface 50. The storage system 44 includes software, including inventory management module 46, and stored data, including data in database structure 48. The processing system 42 loads and executes software, including the inventory management module 46, which is a software application stored in the storage system 44. The processing system 42 can also access data stored in the database 48 in order to carry out the methods and control instructions described herein. Although the computing system 40 is depicted in FIG. 1 as one, unitary system encapsulating one processing system 42 and one storage system 44, it should be understood that one or more storage systems 44, one or more processing systems 42, and one or more user interfaces 50 may comprise the computing system 40, which may be a cloud computing application and system. Similarly, while the inventory management module 46 is schematically depicted as a single software application contained on a single storage system 44, it is to be recognized that the inventory management module 46 may be implemented as various software instruction sets, or modules, stored at various locations, such as on various storage systems. The processing system 42 includes a processor, which may be a microprocessor, a general purpose central processing unit, an application-specific processor, a microcontroller, or any type of logic device. The processing system 42 may also include circuitry for retrieving and executing software, including the inventory management module 46, from the storage system 44. The processing system 42 may be implemented with a single processing device, but may also be distributed across multiple processing devices or subsystems that cooperate in executing software instructions.

Storage system 44, which stores database 48, may comprise any storage media, or group of storage media, readable by processing system 42, and capable of storing software and data. Storage system 44 can include volatile and non-volatile, removable and non-removable media implemented in any method or technology for storage of information, such as computer-readable instructions, data structures, program modules, or other data. As described above, storage system 44 may be implemented as a single storage device, but may also be implemented across multiple storage devices or subsystems located at disparate locations and communicatively connected, such as in a cloud computing system. Examples of storage media include random access memory, read only memory, optical discs, flash memory, virtual memory, and non-virtual memory, or any other medium which can be used to store the desired information and may be accessed by a processing system 42.

The inventory management module 46 operates to control and produce the end-user functionality of the inventory management system 1. For example, the inventory management module 46 determines an inventory amount based on the distance measured by the distance sensor 4. Additionally, the inventory management module 46 may function to track any of a variety of inventory management and system parameters, and to provide information to a user regarding those aspects. For example, the inventory management module 46 may provide real time results measured during the inventory scanning process, may provide inventory notifications regarding low inventory or misplaced inventory, may provide planogram compliance information, and/or may store and/or report information regarding the environmental parameters measured by the sensors on the scanning system 3. Alternatively or additionally, the inventory management module 46 may access control instructions for a particular pulley system 20 at a particular location, and may transmit such program instructions from receiver/transmitter 21 to the aggregator system 33 for execution by the motor controller 28. Accordingly, the inventory management module 46 may determine when a scanning exercise should occur. For example, the inventory management module 46 may instruct scanning the inventory locations in the scanning plane 12 in a cooler every time the door to the cooler is opened and then closed (indicating that one or more items 62 may have been removed from the cooler). For example, the system may include a door sensor that senses whether a door of the cooler is open or closed, such as a position sensor on a switch that opens (or closes) when the door is opened. Alternatively or additionally, the inventory management module 46 may instruct periodic scanning of the scanning plane 12.

The light sensor 9 may be any sensor capable of determining a light level surrounding the scanning system 3, or the portion containing the light sensor. The light level may be used to assess certain conditions and operations within a storage environment, such as an upright cooler 69. For example, a light may be illuminated when the cooler door is opened. If the cooler door is opened and the light does not illuminate, as measured by the light sensor 9, an indicator may be provided to a user via the inventory management module 46 that the light is not functioning properly and that the bulb may need to be replaced. Similarly, if the light remains on when the door is closed, a malfunction notification may be provided to a user. Additionally, where the cooler is configured such that a light turns on when the door is opened, the light sensor 9 can provide a backup or verification, sensing operation to the door position sensor which can be used by the inventory management module 46 to determine when to execute a scanning operation. Where the lighting is user-controlled, the information regarding lighting may be relevant to tracking information about the cooler, such as when it was stocked (e.g., for a walk-in cooler).

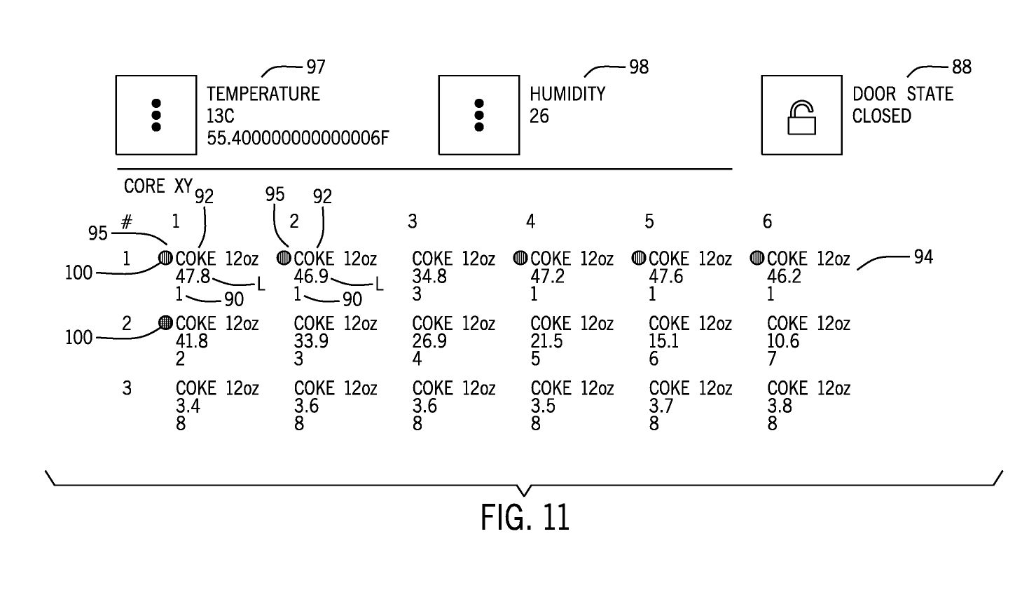

FIG. 11 depicts one embodiment of a display 88 on a user interface 50 of the computing system 40 that provides information generated by a scanning process. The display 88 includes a table 94 providing a series of table locations 95, where each table location 95 represents an inventory location 55 in the scanning plane 12 and displays information regarding the respective inventory location 55. In the depicted embodiment, each table location 95 provides an inventory amount 90, which is determined based on the distance L. This distance L is also displayed. An item indicator 92 is also displayed indicating the item at the inventory location 55. For example, the item indicator 92 may be determined based on the information gathered by the tag reader 10. Alternatively, the item indicator 92 may be determined based on a planogram for the respective scanning plane 12. For example, the planogram may be a grid or table similar to the table 94 and dictating which product should be placed at each inventory location. In embodiments where a tag reader is not present in the scanning system 3, the inventory management module 46 may assume that 100% planogram compliance and may determine an inventory amount based on the measure distance L at each inventory location and the retail item identified in the planogram.

The inventory management module 46 determines the inventory amount based on the distance L measured at each inventory location. Depending on the arrangement of the inventory location (e.g. a cooler versus a bulk bin), the inventory management module 46 may be configured to differently determine the inventory amount based on the distance L. The inventory management module 46 may further determine the inventory amount based on the type of item contained at the inventory location, which may be an item identification read by the tag reader 10 or may be determined based on a planogram for the scanning plane 12. For example, the inventory management module 46 may have information regarding the dimensions of various identified items or item types, such as item dimensions. Accordingly, the distance L measured by the distance sensor 4 is divided by a corresponding dimension of the item 62—the depth on the retail item occupying the retail location—to arrive at the inventory amount. In the instance of the bulk bin 80 embodiment, the inventory amount may be determined as a percentage fill amount of the bulk bin 80.

The inventory amount for each inventory location 55 may be displayed at the respective table location 95 so that the inventory across a scanning plane 12 may be assessed, such as for stocking purposes. Additionally, an alert may be provided to alert a user to certain inventory locations 55 where the inventory amount is below a low inventory threshold, such as indicating that the inventory of items 62 at that inventory location 55 needs to be restocked. Similarly, the inventory amount or inventory threshold may be determined based on the distance L alone, such as by comparing the measured distance L to a distance threshold, such as a maximum distance value representing low inventory. Referring to the exemplary user interface display 88 at FIG. 11, the alert may be a visual alert 100 provided at a location corresponding to the relevant inventory location 55 where the low inventory has been detected. In the example, the visual alert is a color indicator that indicates a low inventory level, with a red mark indicating very low or no retail items 62 at the respective inventory location 55, and a yellow dot indicting low inventory at the corresponding inventory location 55. Various other embodiments of visual or other alerts are within the scope of the invention, such as a separate alert report representing all inventory locations 55 where one or more low inventory thresholds are crossed.

The inventory management module 46 may further provide information to a user regarding the environmental conditions of the relevant scanning plane 12. For example, information may be provided regarding the temperature and/or humidity within the scanning plane. In the exemplary display 88 shown in FIG. 11, a temperature display 97 shows a single temperature. For example, the temperature display 97 may display the lowest or highest temperature measured in the scanning plane 12. Alternatively, the sensor 8 may measure temperature at only one location within the cooler, which may be reported at the temperature display 97. In still other embodiments, the inventory management module 46 may take an average of all temperature measurements made in the scanning plane, and may report that average temperature. Similarly, the display 88 includes a humidity display based on humidity measurements measured by the sensor 8. The humidity value provided in the humidity display 98 may be determined in any number of ways, similar to that described with respect to temperature. In still other embodiments, the inventory management module 46 may be configured to receive temperature and/or humidity measurements from a plurality of locations in the scanning plane 12 and to create a temperature and/or humidity map of the scanning plane 12. Such information may be provided to a user, such as to identify hot spots or cold spots within the scanning plane and/or to identify issues or problems within the scanning environment, such as within the cooler. Additionally, the display 88 may provide other information about the environment of the scanning plane 12, such as whether the cooler door is open or closed, whether a light within the cooler is on or off, or the like.

The inventory management system 1 may be configured to be modular so that the computing system 40 and the aggregator system 33 are configured to monitor and control multiple different pulley systems 20 and associated scanning systems 3. For example, a scanning system 3 and pulley system 20 may be installed in each of a number of locations in a retail environment, all of which may communicate to the aggregator system 33, which in turn communicates with the computing system 40. Accordingly, additional scanning systems, including a scanning system 3 and pulley system 20 may be added or subtracted as needed without changing the infrastructure of the system 1. Accordingly, the system 1 can be easily scaled up or scaled down to fit any retail environment.

Another function of the inventory management module 46 may be planogram compliance monitoring. For example, the inventory management module 46 may receive a planogram for each scanning plane 12. In embodiments of the system 1 where the scanning system 3 includes a tag reader 10 that determines an item identification for the retail item 62 at each inventory location 55, a planogram compliance value can be determined. The item identification at each inventory location 55 is compared to the item identified at the respective planogram location to determine whether the correct item is in that inventory location 55. If not, an alert may be provided to a user to check the inventory at the respective inventory location 55. Thus, the planogram compliance value may include a compliance indicator for each inventory location 55, such as a positive or negative value indicating a match or mismatch between the item identification and the planogram. Additionally, the inventory management module 46 may track statistical or aggregated planogram compliance value(s), such as a percentage of compliance between the item identification at all inventory locations 55 and the corresponding planogram(s), an average compliance over time, or compliance percent for a particular product or brand of products. This provides valuable information to product owners and vendors regarding whether or not a planogram is being followed in a particular retail environment.

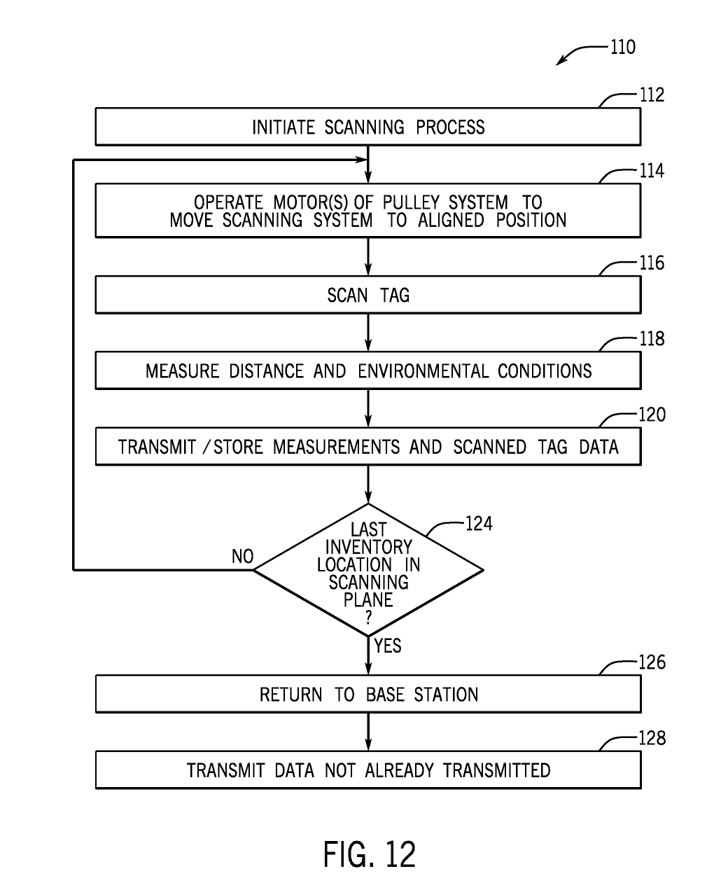

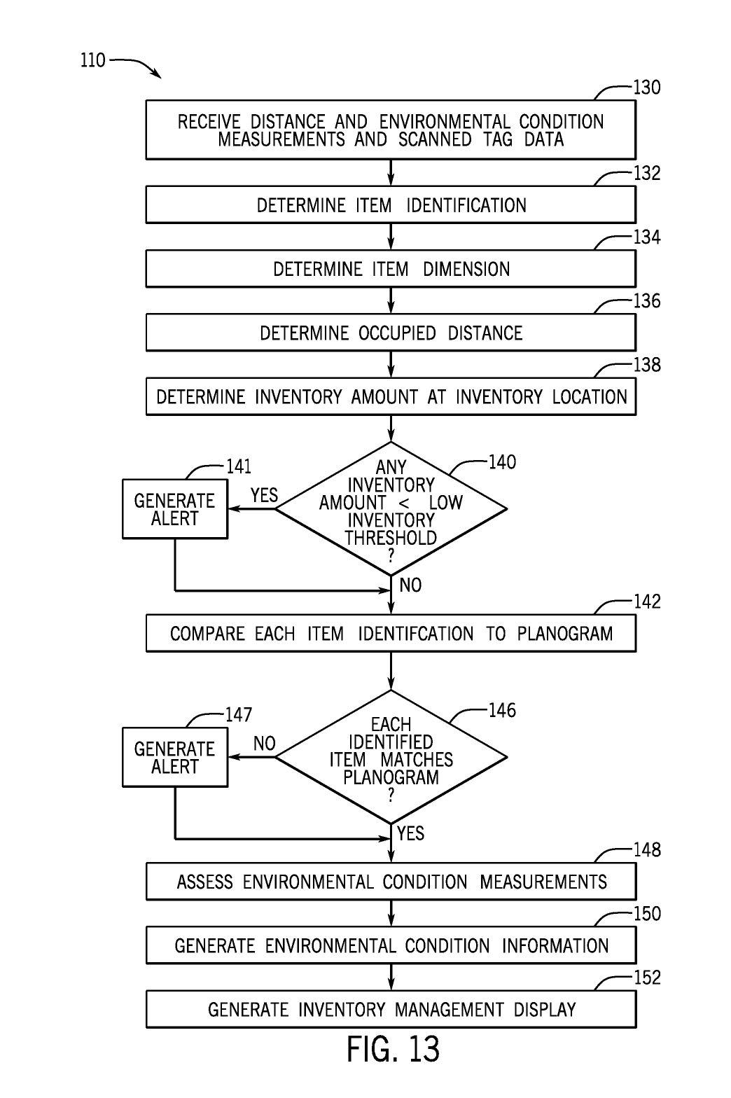

FIGS. 12 and 13 depict an embodiment of a method 110, or portions thereof, of assessing current inventory provided in a retail display. FIG. 12 shows method steps representing a scanning process, such as executed by the scanning system 3 and the motor controller 28, which may be in further coordination with the inventory management module 46 and/or the aggregator system 33. A scanning process is initiated at step 112. As described above, the scanning process may be initiated by various mechanisms and/or under various conditions. For example, the scanning process may occur periodically, or may occur upon detection of predetermined events, such as an opening and closing of a refrigerator door, detection of motion in or around the retail display, or the like. The logic for determining the scanning process initiation may be executed by any one or more of the inventory management module 46, the aggregator system 33, the motor controller 28 and/or the scanning system 3. Once the scanning process is initiated, the motors of the pulley system are operated at step 114, such as resulting from instructions by the motor controller 28, to move the scanning system 3 to an aligned position with a first inventory location 55. In embodiments having a tag reader 10, the tag reader 10 may scan a tag 64 located at or near the aligned position, as represented at step 116. The scanning system 3 conducts various measurements at step 118, including measuring the distance L to the retail item(s) 62. Various environmental condition measurements may also be conducted, as described above, such as temperature/humidity measurements, light measurements, etc.

At step 120 the various measurements and scanned tag data are transmitted and/or stored. For example, the measurements may be stored at a memory on the scanning system 3. Then, upon completion of a scanning process across a scanning axis or plane, all measurements may be transmitted to the aggregator system 33 or the computing system 40, such as when the scanning system 3 returns to the base station 16. Thereby, energy usage may be minimized during the scanning process so as to reduce the amount of energy consumed from the battery 6. Alternatively, the various measurements at each aligned position may be transmitted as they are made, or a wireless transmission may be made following completion of all measurements at each aligned position. Logic is executed at step 124 to determine whether every inventory location on a scanning axis or in a scanning plane has been reached, or whether scanning should continue by returning to step 114. Once all inventory locations have been scanned, the scanning system 3 returns to the base station at step 126. Any stored data that was not transmitted is then communicated at step 128, such as to the aggregator system 33 and/or the computing system 40.

FIG. 13 depicts various steps for conducting an inventory assessment based on the measured data. Such steps may be executed, for example, by the inventory management module 46, which may be on the computing system 40. In certain embodiments, portions of the inventory management module 46 may also be housed within and executed by the aggregator system 33. The distance measurements, environmental condition measurements, and/or scanned tag data is received at step 130. The measurements from each inventory location are then assessed. An item identification for an inventory location 55 is determined at step 132, such as based on the scanned tag data. A corresponding item dimension is accessed at step 134 based on the item identification. For example, as described above, the item dimension may be a depth of the item on the shelf in the direction of the distance measurement L at the inventory location 55. Such data may be available, for example, based on the type of item (e.g. 12 oz can) identified. An occupied distance is also determined at step 136, such as the amount of space occupied by the retail items 62 on a retail shelf or bulk items 62 in a bulk bin. For example, the occupied distance may be determined based on a known maximum distance between the distance sensor 4 and the furthest edge of the retail location 5, such as the bottom of the bulk bin 80 or the front end 58 of the shelf 57. For example, the occupied distance may be the known maximum distance minus the distance measurement L. The inventory amount at the inventory location is then determined at step 138 based on the item dimension and the occupied distance, such as by dividing the occupied distance by the item dimension. In other embodiments, the inventory amount may be determined based on the distance measurement L by other means. For example, a lookup table may be available correlating distance measurements L to inventory amounts, such as based on item type or based on inventory location 55.

In certain embodiments, the distance measurement L may be impacted by various error factors, such as the placement or orientation or the retail items 62, the configuration or function of the pusher 61 applying force to the retail item 62, etc. Thus, the system may be configured to account for variation in the distance measurement L, and thus some rounding or approximation may occur in determining the inventory amount. For example, the system may be configured to round up or down to the nearest round number.

Logic may then be executed to assess inventory amounts, the environmental conditions of the retail display, and/or planogram compliance. As exemplified in FIG. 13, the inventory amount at each inventory location 55 may be compared to one or more low inventory thresholds at step 140. If a low inventory threshold is detected at any particular inventory location 55, the system may generate an alert at step 141, such as a visual alert on the display 88 associated with the respective inventory location 55 where the low inventory has been detected. Each item identification is compared at step 142 to an item identified for that inventory location 55 on a planogram. If any identified item at an inventory location 55 fails to match the item prescribed by the planogram at step 146, then a mismatch or planogram noncompliance alert is generated at step 147. The environmental conditions may also be assessed, represented at step 148, such as to detect hot spots or cold spots in the retail environment, locations of especially high humidity, malfunctions of the light in the upright cooler, etc. Environmental condition information is then generated at step 150 and an inventory management display is provided at step 152, such as is exemplified in FIG. 11.

This written description uses examples to disclose the invention, including the best mode, and also to enable any person skilled in the art to make and use the invention. Certain terms have been used for brevity, clarity and understanding. No unnecessary limitations are to be inferred therefrom beyond the requirement of the prior art because such terms are used for descriptive purposes only and are intended to be broadly construed. The patentable scope of the invention is defined by the claims, and may include other examples that occur to those skilled in the art. Such other examples are intended to be within the scope of the claims if they have features or structural elements that do not differ from the literal language of the claims, or if they include equivalent features or structural elements with insubstantial differences from the literal languages of the claims.

We claim:

1. An inventory management system comprising:
a scanning system including:
a distance sensor configured to measure a distance to a retail item at an inventory location;
a transmitter configured to transmit the distance measurement;
a pulley system configured to move the scanning system along at least one axis, the pulley system comprising:
at least two pulleys;
a connection line between the at least two pulleys and connected to the scanning system;
a stationary motor configured to move the connection line with respect to the at least two pulleys;
a controller configured to control the stationary motor to move the scanning system to an aligned position with each inventory location in a series of inventory locations; and
an inventory management module configured to determine an inventory amount at each inventory location based on the distance measurement at the respective inventory location.

2. The inventory management system of claim 1, wherein the pulley system includes at least two stationary motors that move the connection line with respect to at least eight pulleys, wherein the pulley system is configured to move the distance sensor in both a vertical direction and a horizontal direction within a scanning plane.

3. The inventory management system of claim 2, wherein the inventory locations are on a shelving unit and the pulley system is mounted behind the shelving unit so as to move the distance sensor within the scanning plane behind the shelving unit, wherein the distance sensor measures a distance to a rear-most retail item at each inventory location.

4. The inventory management system of claim 2, the scanning system further including a tag reader configured to read a tag associated with each inventory location so as to provide an item identification of the retail item for that inventory location to the inventory management module.

5. The inventory management system of claim 4, wherein the inventory management module is configured to determine the inventory amount based further on the item identification.

6. The inventory management system of claim 5, wherein the inventory management module is further configured to compare the inventory amount to a low inventory threshold, and to generate an alert when the inventory amount is below the low inventory threshold.

7. The inventory management system of claim 4, wherein the inventory management module is further configured to compare the item identification associated with each inventory location to a planogram to determine a planogram compliance value.

8. The inventory management system of claim 3, wherein the scanning system is supported on and movable in the horizontal direction across a carrier plate, wherein the pulley system moves the carrier plate in the vertical direction.

9. The inventory management system of claim 8, wherein the shelving unit and inventory locations are in an upright cooler, and the scanning system is moved within the scanning plane adjacent to a back wall of the upright cooler to determine an inventory amount at the series of inventory locations in the upright cooler.

10. The inventory management system of claim 9, the scanning system further including at least one of a temperature sensor configured to measure a temperature at a plurality of locations within the scanning plane and a humidity sensor configured to measure a humidity at the plurality of locations within the scanning plane; and
wherein the inventory management module is further configured to provide environmental condition information of the upright cooler based on the humidity measurements and/or the temperature measurements.

11. The inventory system of claim 10, further comprising a light sensor configured to measure a light level in the upright cooler, wherein the inventory management module is further configured to determine whether a cooler door of the upright cooler is open or closed based on last least one of the light level measurement, the temperature measurements, and the humidity measurements.

12. The inventory system of claim 3, wherein the scanning system is supported on a rail and movable in the horizontal direction across the rail, wherein the pulley system moves the rail in the vertical direction on a frame behind the shelving unit.

13. The inventory management system of claim 1, wherein the scanning system is supported on a rail that extends above inventory locations in one or more bulk bins, each bulk bin containing a bulk retail item, wherein the pulley system moves the scanning system to the aligned position above each bulk bin and the distance sensor measures the distance to the bulk retail item contained in each bulk bin.

14. The inventory management system of claim 13, the scanning system further including a tag reader configured to read a tag associated with each inventory location so as to provide an item identification for the bulk retail item at that inventory location to the inventory management module, and wherein the inventory management module is further configured to determine the inventory amount based further on the item identification.

15. A method of assessing inventory in a retail display, the method comprising:
operating a pulley system to move a scanning system to an aligned position with each inventory location in a series of inventory locations;
at each inventory location, operating the scanning system to measure a distance to a retail item;
wirelessly transmitting the distance measurement for each inventory location to a receiver; and
determining, with a processor, an inventory amount at each inventory location based on the distance measurement at the respective inventory location.

16. The method of claim 15, further comprising reading a tag associated with each inventory location with a tag reader on the scanning system;
determining item identification of the retail item based on the tag; and
determining the inventory amount based further on the item identification.

17. The method of claim 16, further comprising comparing the inventory amount to a low inventory threshold; and
generating an alert when the inventory amount is below the low inventory threshold.

18. The method of claim 17, wherein determining the inventory amount based further on the item identification includes:
determining a dimension of the retail item based on the item identification;
determining an occupied distance based on the distance measurement at each inventory location and a known maximum distance at the respective inventory location; and
determining the inventory amount based on the occupied distance and the dimension of the retail item.

19. The method of claim 16, further comprising:
comparing the item identification associated with each inventory location to a planogram; and
determining a planogram compliance value based on the comparison.

20. The method of claim 15, wherein the inventory locations are in an upright cooler and wherein the pulley system is configured to move the scanning system within a scanning plane adjacent to a back wall of the upright cooler, and further comprising:
measuring at least one of a temperature or a humidity at a plurality of the aligned positions within the scanning plane; and
providing environmental condition information of the upright cooler based on the humidity measurements and/or the temperature measurements.
